(19) United States
(12) Patent Application Publication
(10) Pub. No.: US 2012/0098918 A1
(43) Pub. Date: Apr. 26, 2012

(54) VIDEO ANALYTICS AS A TRIGGER FOR VIDEO COMMUNICATIONS

(76) Inventor: William A. Murphy, Glace Bay (CA)

(21) Appl. No.: 13/198,233

(22) Filed: Aug. 4, 2011

Related U.S. Application Data
(60) Provisional application No. 61/370,527, filed on Aug. 4, 2010.

(51) Int. Cl. H04N 7/14

(52) U.S. Cl. 348/14.01; 348/E07.077

(57) ABSTRACT

A method comprises defining a predetermined trigger event and, using a sensor, sensing at least one of audio, image and video data within a predetermined sensing area of the sensor. A process in execution on a processor of a first system is used to perform at least one of audio, image and video analytics of the at least one of audio, image and video data, to detect an occurrence of the predetermined trigger event within the predetermined sensing area. When a result of the at least one of audio, image and video analytics is indicative of an occurrence of the predetermined trigger event, a communication session for communicating with an individual within the predetermined sensing area is initiated automatically.

This application claims the benefit of U.S. Provisional Patent Application No. 61/370,527, filed on Aug. 4, 2010, the entire contents of which are incorporated herein by reference.

### FIELD OF THE INVENTION

The instant invention relates generally to electronic communication methods and systems, and more particularly to a method and system for initiating video calls.

### BACKGROUND OF THE INVENTION

Telecommunication technologies allow two or more parties to communicate almost instantly, even over vast distances. In the early part of the last century, landline telephones became essentially ubiquitous in developed countries. More recently, cellular wireless telephone networks have emerged, allowing parties to communicate with one another from virtually anywhere within a cellular network coverage area.

Videoconferencing has also emerged recently as a viable alternative to voice-only communication. A videoconference is a set of interactive telecommunication technologies, which allow two or more parties to interact via two-way video and audio transmissions simultaneously. Webcams are popular, relatively low cost devices that can provide live video streams via personal computers, and can be used with many software clients for videoconferencing over the Internet.

Voice over Internet Protocol (VoIP) software clients, such as for instance Skype®, support voice-only and/or videoconferencing communication between two or more parties. During use, the VoIP application is in execution on a computer or on another suitable device that is associated with a first party. The VoIP application typically provides a list of user names associated with other parties, including an indication of the current status of each of the other parties. When a second party appears to be available, the first party may attempt to initiate a communication session with the second party. For instance, the first party selects a user name associated with the second party from the list, and then selects an option for initiating a “call” to the second user. The VoIP application that is in execution on a computer or on another suitable device associated with the second party causes an alert to be issued, such as for instance playing a “ringing” sound via a speaker of the computer or other suitable device. In response to the alert, the second party answers the “call” originating from the first party.

Unfortunately, the indicated status of the second party often does not reflect the actual status of the second party. For instance, the second party may fail to change the status indicator from “online” to “away,” especially during short or unexpected breaks, etc. Similarly, the second party may fail to change the status indicator from “online” to “do not disturb” at the start of an important meeting. Accordingly, it is often the case that the current status indicator for the second party does not represent the true status of the second party. It is a disadvantage of the prior art that the first party may attempt to contact the second party either at a time when the second party is not present, or at a time when the second party does not wish to be disturbed.

It would be advantageous to provide a method and system for making video calls that overcomes at least some of the above-mentioned limitations of the prior art.

### SUMMARY OF EMBODIMENTS OF THE INVENTION

In accordance with an aspect of the invention there is provided a method comprising: defining a predetermined trigger event; using a sensor, sensing at least one of audio, image and video data within a predetermined sensing area; using a process in execution on a processor of a first system, performing at least one of audio, image and video analytics of the at least one of audio, image and video data, to detect an occurrence of the predetermined trigger event within the predetermined sensing area; and, when a result of the at least one of audio, image and video analytics is indicative of an occurrence of the predetermined trigger event, automatically initiating a communication session for communicating with an individual within the predetermined sensing area.

According to another aspect, the invention provides for a method wherein the first system is co-located with the sensor, and wherein the communication session is between the first system and a second system that is remote from the sensor.

According to another aspect, the invention provides for a method wherein the first system is remote from the sensor, and wherein the communication session is between the first system and a second system that is co-located with the sensor.

According to another aspect, the invention provides for a method wherein the first system is a network server, and wherein the communication session is between a second system that is co-located with the sensor and a third system that is remote from the server.

According to another aspect, the invention provides for a method comprising transmitting the sensed at least one of audio, image and video data from the sensor to the first system via a communication network prior to performing the at least one of audio, image and video analytics.

According to another aspect, the invention provides for a method wherein the communication session is a bidirectional Voice over Internet Protocol (VoIP) communication session.

According to another aspect, the invention provides for a method wherein sensing comprises capturing video data using a video capture device, and wherein performing comprises performing video analytics of the video data.

According to another aspect, the invention provides for a method wherein the predetermined trigger event is a second event of a compound trigger event, the compound trigger event comprising a first event and the second event.

According to another aspect, the invention provides for a method wherein the predetermined trigger event comprises identifying uniquely the individual within the predetermined sensing area, based on the at least one of audio, image and video analytics of the at least one of audio, image and video data.

According to another aspect, the invention provides for a method wherein the individual is a contact of a first user, and wherein the communication session is initiated between the first user and the individual.

According to another aspect, the invention provides for a method wherein initiating the communication session comprises providing to the first user an indication of the identity of the individual.

According to another aspect, the invention provides for a method wherein the at least one of audio, image and video analytics is video analytics, and comprising comparing captured video data from the predetermined sensing area with template data for the individual.

According to another aspect, the invention provides for a method wherein the template data comprises a plurality of facial images of the individual.

In accordance with an aspect of the invention there is provided a method comprising: defining a predetermined trigger event; using a sensor, sensing at least one of audio, image and video data within a predetermined sensing area; transmitting the sensed at least one of audio, image and video data to a first system via a communication network; using a process in execution on a processor of the first system, performing at least one of audio, image and video analytics of the at least one of audio, image and video data, to detect an occurrence of the predetermined trigger event within the predetermined sensing area; and, when a result of the at least one of audio, image and video analytics is indicative of an occurrence of the predetermined trigger event, automatically initiating a bidirectional communication session for communicating with an individual within the predetermined sensing area.

According to another aspect, the invention provides for a method wherein the communication network is an Internet Protocol (IP) network.

According to another aspect, the invention provides for a method wherein the bidirectional communication session is a Voice over Internet Protocol (VoIP) communication session.

According to another aspect, the invention provides for a method wherein the bidirectional communication session is between the first system and a second system that is co-located with the sensor.

According to another aspect, the invention provides for a method wherein the first system is a network server, and wherein the bidirectional communication session is between a second system that is co-located with the sensor and a third system, the third system in communication with the first system and with the second system via the communication network.

According to another aspect, the invention provides for a method wherein the bidirectional communication session comprises both a video component and an audio component.

According to another aspect, the invention provides for a method wherein sensing comprises capturing video data using a video capture device, and wherein performing comprises performing video analytics of the video data.

According to another aspect, the invention provides for a method wherein the predetermined trigger event is a second event of a compound trigger event, the compound trigger event comprising a first event and the second event.

According to another aspect, the invention provides for a method wherein the sensor is an edge device, and comprising performing first at least one of audio, image and video analytics of the at least one of audio, image and video data to detect an occurrence of the first event within the predetermined sensing area.

According to another aspect, the invention provides for a method wherein the sensed at least one of audio, image and video data is transmitted from the sensor to the first system in response to detecting the occurrence of the first event within the predetermined sensing area.

According to another aspect, the invention provides for a method wherein transmitting is performed prior to using the processor of the first system for performing the at least one of audio, image and video analytics of the at least one of audio, image and video data.

According to another aspect, the invention provides for a method wherein the predetermined trigger event comprises identifying uniquely the individual within the predetermined sensing area, based on the at least one of audio, image and video analytics of the at least one of audio, image and video data.

According to another aspect, the invention provides for a method wherein the individual is a contact of a first user, and wherein the communication session is initiated between the first user and the individual.

According to another aspect, the invention provides for a method wherein initiating the communication session comprises providing to the first user an indication of the identity of the individual.

According to another aspect, the invention provides for a method wherein the at least one of audio, image and video analytics is video analytics, and comprising comparing captured video data from the predetermined sensing area with template data for the individual.

According to another aspect, the invention provides for a method wherein the template data comprises a plurality of facial images of the individual.

In accordance with an aspect of the invention there is provided a method comprising: providing a sensor at a known location for sensing at least one of audio, image and video data within a sensing area at the known location; using the sensor, sensing at least one of audio, image and video data within the sensing area thereof; transmitting the sensed at least one of audio, image and video data from the sensor to a first system via a communication network; using a process in execution on a processor of the first system, performing at least one of audio, image and video analytics of the at least one of audio, image and video data, to detect an occurrence of a predetermined trigger event at the known location; and, when a result of the at least one of audio, image and video analytics is indicative of an occurrence of the predetermined trigger event, automatically initiating a bidirectional communication session between a second system that is co-located with the sensor and a third system that is remote from the sensor, for communicating with an individual within the predetermined sensing area.

According to another aspect, the invention provides for a method wherein the communication network is an Internet Protocol (IP) network.

According to another aspect, the invention provides for a method wherein the bidirectional communication session is a Voice over Internet Protocol (VoIP) communication session.

According to another aspect, the invention provides for a method wherein the bidirectional communication session comprises both a video component and an audio component.

According to another aspect, the invention provides for a method wherein sensing comprises capturing video data using a video capture device, and wherein performing comprises performing video analytics of the video data.

According to another aspect, the invention provides for a method wherein the predetermined trigger event is a second event of a compound trigger event, the compound trigger event comprising a first event and the second event.

According to another aspect, the invention provides for a method wherein the sensor is an edge device, and comprising performing first at least one of audio, image and video analytics of the at least one of audio, image and video data to detect an occurrence of the first event within the predetermined sensing area.

According to another aspect, the invention provides for a method wherein the sensed at least one of audio, image and video data is transmitted from the sensor to the first system in response to detecting the occurrence of the first event within the predetermined sensing area.

According to another aspect, the invention provides for a method wherein transmitting is performed prior to using the process in execution on the processor of the first system for performing the at least one of audio, image and video analytics of the at least one of audio, image and video data.

According to another aspect, the invention provides for a method wherein the predetermined trigger event comprises identifying uniquely the individual within the sensing area at the known location, based on the at least one of audio, image and video analytics of the at least one of audio, image and video data.

According to another aspect, the invention provides for a method wherein the individual is a contact of a first user, and wherein the communication session is initiated between the first user and the individual.

According to another aspect, the invention provides for a method wherein initiating the communication session comprises providing to the first user an indication of the identity of the individual.

According to another aspect, the invention provides for a method wherein the at least one of audio, image and video analytics is video analytics, and comprising comparing captured video data from the predetermined sensing area with template data for the individual.

According to another aspect, the invention provides for a method wherein the template data comprises a plurality of facial images of the individual.

In accordance with an aspect of the invention there is provided a method comprising: using a sensor, sensing at least one of audio, image and video data relating to a first individual; using a process in execution on a processor of a first system, performing at least one of audio, image and video analytics of the at least one of audio, image and video data, to determine an identity of the first individual; and, initiating a communication session between the first individual and a second individual, wherein the second individual is selected based on the determined identity of the first individual, from a group of second individuals that are associated with the first individual.

According to another aspect, the invention provides for a method wherein the first individual is identified uniquely.

According to another aspect, the invention provides for a method wherein the first individual is identified as a member of a group of known first individuals.

According to another aspect, the invention provides for a method wherein the second individual is associated with each first individual of the group of known first individuals.

According to another aspect, the invention provides for a method wherein the communication session between the first individual and a second individual is initiated automatically.

According to another aspect, the invention provides for a method wherein the communication session between the first individual and a second individual is initiated manually.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1a is a simplified schematic diagram showing a system according to an embodiment of the instant invention, when a second party is absent;

FIG. 1b is a simplified schematic diagram showing the system of FIG. 1a when the second party is present;

FIG. 2 is a simplified flow diagram of a method according to an embodiment of the instant invention;

FIG. 3 is a simplified flow diagram of a method according to an embodiment of the instant invention;

FIG. 4 is a simplified flow diagram of a method according to an embodiment of the instant invention;

FIG. 5 is a simplified flow diagram of a method according to an embodiment of the instant invention;

FIG. 6 is a simplified flow diagram of a method according to an embodiment of the instant invention; and,

FIG. 7 is a simplified flow diagram of a method according to an embodiment of the instant invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

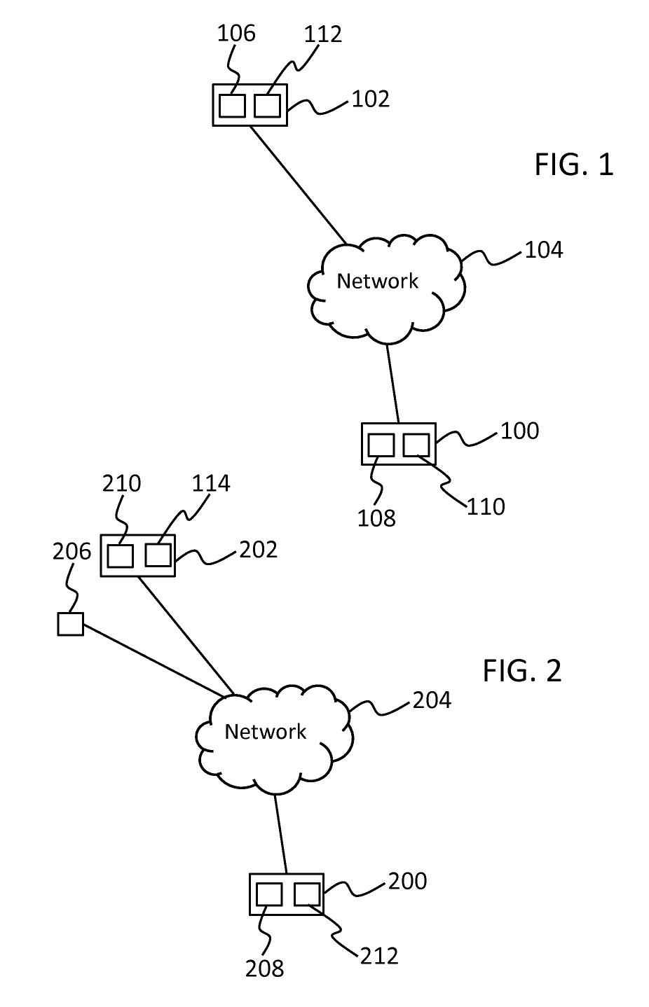

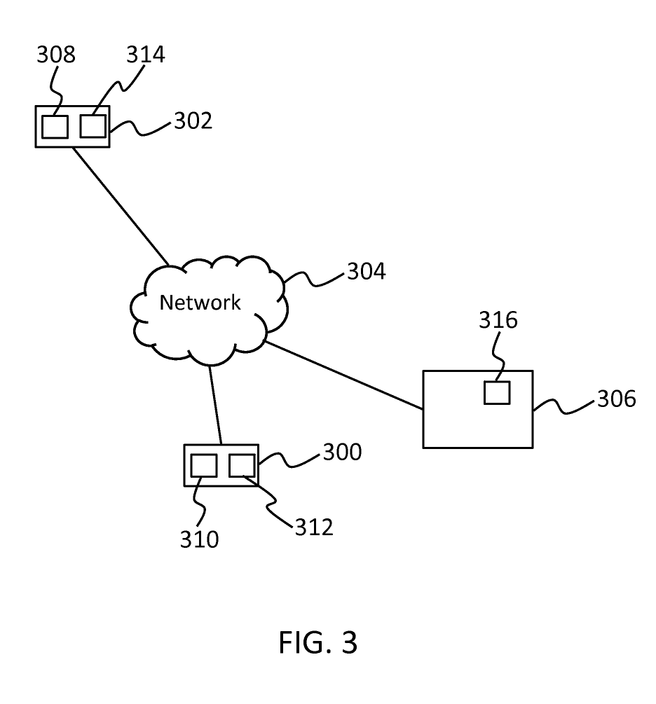

FIG. 1 is a simplified block diagram of a system according to an embodiment of the instant invention. A first user system 100 is provided in communication with a second user system 102, via a communication network 104. For instance, the communication network 104 is an Internet Protocol (IP) network. The first user system 100 is associated with a first user and the second user system 102 is associated with a second user. At least the second user system 102 comprises an electronic sensor 106 for sensing data within a sensing area of the second user system 102. For instance, the electronic sensor 106 is one of an audio sensor for sensing audio data and an image sensor for sensing image or video data. In order to support bidirectional audio and video communication between the first user and the second user, the first user system 100 also comprises an electronic sensor 108. In one specific implementation, both the first user system 100 and the second user system 102 each comprise both an audio sensor and a video sensor. By way of a specific and non-limiting example, the first user system 100 and the second user system 102 each comprise a microphone and a web cam or another type of video camera. Optionally, one or both of the microphone and the web cam are external peripheral devices of the first and second user systems. Optionally, one or both of the microphone and the web cam are integrated devices of the first and second user systems.

The first user system 100 further comprises a processor 110 and the second user system 102 further comprises a processor 112, the processors 110 and 112 being for executing machine readable code for implementing at least one of an email application, a social networking application, a Voice over Internet Protocol (VoIP) application such as for instance Skype®, an instant messaging (IM) application, or another communication application. Furthermore, the processor 110 and/or 112 is for analyzing data that are sensed using the sensor 106 of the second user system 102. In particular, the analysis comprises at least one of audio, image and video analytics of the sensed data. More particularly, the analysis comprises comparing the sensed data with template data relating to a predetermined trigger event. In one implementation, the predetermined trigger event is one of a plurality of different events defining a compound event. For instance, the compound event comprises the predetermined trigger event and at least one additional trigger event. Optionally, the electronic sensor 106 of the second user system 102 is an edge device that is capable of performing the at least one of audio, image and video analytics of the data that are sensed thereby.

In accordance with a first operating mode of the system of FIG. 1, the electronic sensor 106 is used to sense data within a sensing area thereof. For instance, the electronic sensor 106 senses at least one of audio, image and video data within the sensing area. The sensed data is provided to processor 112 of the second user system. Using a process in execution on the processor 112, at least one of audio, image and video analytics of the sensed data is performed. In particular, the analysis comprises comparing the sensed data with template data relating to a predetermined trigger event. When a result of the analysis is indicative of an occurrence of the predetermined trigger event within the sensing area, a communication session is automatically initiated for communicating with an individual within the predetermined sensing area. For instance, a communication session is initiated between the second user system 102 and the first user system 100. By way of a specific and non-limiting example, the communication session is a bidirectional Voice over Internet Protocol (VoIP) communication. Optionally, the communication session comprises a video component and an audio component.

A specific and non-limiting example will now be provided in order to facilitate a better understanding of the first operating mode of the system according to FIG. 1. In the specific and non-limiting example, the sensor 106 is a video camera, the first user system 100 is located within the premises of a first individual, and the second user system 102 is located within the premises of the elderly parent of the first individual. The first user system 100 and the second user system 102 are Internet connected devices, and each comprises a display screen and speakers. A predetermined trigger event is defined in terms of the elderly parent falling to the ground. Optionally, a plurality of additional trigger events are defined, such as for instance identifying uniquely the elderly parent, the elderly parent walking with a shuffling gait, or the elderly parent remaining motionless. During use, the sensor 106 captures video data within a sensing area of the elderly parent's premises, such as for instance within the living room of the elderly parent's premises, in a substantially continuous fashion. A video analytics process that is in execution on processor 112 performs video analytics of the captured video data. In particular, the video analytics comprises comparing the captured video data with template data relating to the predetermined trigger event. When a result of the video analytics is indicative of an occurrence of the predetermined trigger event, a communication session is initiated between the second system 102 and the first system 100. In this specific example, a bidirectional VoIP communication session is initiated. Optionally, the VoIP communication session is a tele-video session, allowing the first individual to both see and speak to the elderly parent. Based on an assessment of the situation during the communication session, the first individual may determine whether or not the elderly parent requires outside assistance.

Optionally, the predetermined trigger event is a compound event, comprising a first trigger event and a second trigger event. For instance, the first event is defined in terms of the elderly parent falling to the ground and the second event is defined in terms of the elderly parent failing to stand up after falling. At least a process in execution on the processor 112 of the second user system 102 is used to detect an occurrence of both the first event and the second event prior to initiating the communication session. In this way, the occurrence of false alarms is reduced and the elderly parent is able to live with greater independence and privacy. Optionally, the compound event includes a combination of audio and visual events. For instance, the first event is a visual event defined in terms of the elderly parent falling to the ground and the second event is an audio event defined in terms of the elderly parent calling for help. Further optionally, one of the trigger events requires identifying uniquely the elderly parent. Further optionally, the video camera captures frames of image data at known time intervals, and a process in execution on the processor 112 of the second user system 102 performs image analysis, such as to determine when the parent has fallen to the ground. When it is determined that the parent has fallen to the ground, the video camera begins providing full frame-rate video data, and a process in execution on the processor 112 of the second user system 102 performs video analytics to detect another trigger event, such as for instance the elderly parent remaining motionless or the elderly parent failing to stand up.

According to the first operating mode of the system of FIG. 1, the at least one of audio, image and video analytics is performed using a process in execution on the processor of the second user system 102, such that the sensed data is not provided to a remote location. The first operating mode affords a substantial level of privacy.

In accordance with a second operating mode of the system of FIG. 1, the electronic sensor 106 is used to sense data within a sensing area thereof. For instance, the electronic sensor 106 senses at least one of audio, image and video data within the sensing area. The sensed data is provided to processor 110 of the first user system 100, via communication network 104. Using a process in execution on the processor 110, at least one of audio, image and video analytics of the sensed data is performed. In particular, the analysis comprises comparing the sensed data with template data relating to a predetermined trigger event. When a result of the analysis is indicative of an occurrence of the predetermined trigger event within the sensing area, a communication session is automatically initiated for communicating with an individual within the predetermined sensing area. For instance, a communication session is initiated between the first user system 100 and the second user system 102. By way of a specific and non-limiting example, the communication session is a bidirectional Voice over Internet Protocol (VoIP) communication. Optionally, the communication session comprises a video component and an audio component.

A specific and non-limiting example is provided in order to facilitate a better understanding of the second operating mode of the system according to FIG. 1. In the specific and non-limiting example, the sensor 106 is a video camera, the first user system 100 is located within the premises of a first individual, and the second user system 102 is located within the premises of the elderly parent of the first individual. The first user system 100 and the second user system 102 are Internet connected devices, and each comprises a display screen and speakers. A predetermined trigger event is defined in terms of the elderly parent falling to the ground. Optionally, a plurality of additional trigger events are defined, such as for instance identifying uniquely the elderly parent, the elderly parent walking with a shuffling gait, or the elderly parent remaining motionless. During use, the sensor 106 captures video data within a sensing area of the elderly parent's premises, such as for instance the living room of the elderly parent's premises, in a substantially continuous fashion. The captured video data is provided via communication network 104 to processor 110 of the first user system 100. A video analytics process in execution on processor 110 performs video analytics of the captured video data. In particular, the video analytics comprises comparing the captured video data with template data relating to the predetermined trigger event. When a result of the video analytics is indicative of an occurrence of the predetermined trigger event, a communication session is initiated between the first system 100 and the second system 102. In this specific example, a bidirectional VoIP communication session is initiated. Optionally, the VoIP communication session is a tele-video session, allowing the first individual to both see and speak to the elderly parent. Based on an assessment of the situation during the communication session, the first individual may determine whether or not the elderly parent requires an outside response.

Optionally, the predetermined trigger event is a compound event, comprising a first trigger event and a second trigger event. For instance, the first event is defined in terms of the elderly parent falling to the ground and the second event is defined in terms of the elderly parent failing to stand up after falling. At least a process in execution on the processor 110 of the first user system 102 is used to detect an occurrence of both the first event and the second event prior to initiating the communication session. In this way, the occurrence of false alarms is reduced and the elderly parent is able to live with greater independence and privacy. Optionally, the compound event includes a combination of audio and visual events. For instance, the first event is a visual event defined in terms of the elderly parent falling to the ground and the second event is an audio event defined in terms of the elderly parent calling for help.

In a variation of the second operating mode, the video camera captures frames of image data at known time intervals, and the individual frames are transmitted to the first user system 100 via the communication network 104. A process in execution on the processor 110 of the first user system 100 performs image analysis, such as to determine when the parent has fallen to the ground. When it is determined that the parent has fallen to the ground, the first user system 100 transmits a request to the second user system 102, via communication network 104, requesting full frame-rate video. In response to the request, the video camera begins providing full frame-rate video data, and a process in execution on the processor 110 of the first user system 100 performs video analytics to detect another trigger event, such as for instance the elderly parent remaining motionless or the elderly parent failing to stand up. When a result of the video analytics is indicative of an occurrence of the other trigger event, a communication session is initiated between the first system 100 and the second system 102. In this specific example, a bidirectional VoIP communication session is initiated. Optionally, the VoIP communication session is a tele-video session, allowing the first individual to both see and speak to the elderly parent. Based on an assessment of the situation during the communication session, the first individual may determine whether or not the elderly parent requires an outside response. Since the time interval between individual frames typically is relatively short, for instance between 1 second and 10 seconds, the response time is not increased substantially. Optionally, the video camera captures full frame-rate video for storage in a memory device local to the second user system 102. The full frame-rate video is not provided to a remote location, such as the first user system 100, until image analysis of the individual frames is indicative of an occurrence of the trigger event. In this case, the second operating mode also affords a substantial level of privacy.

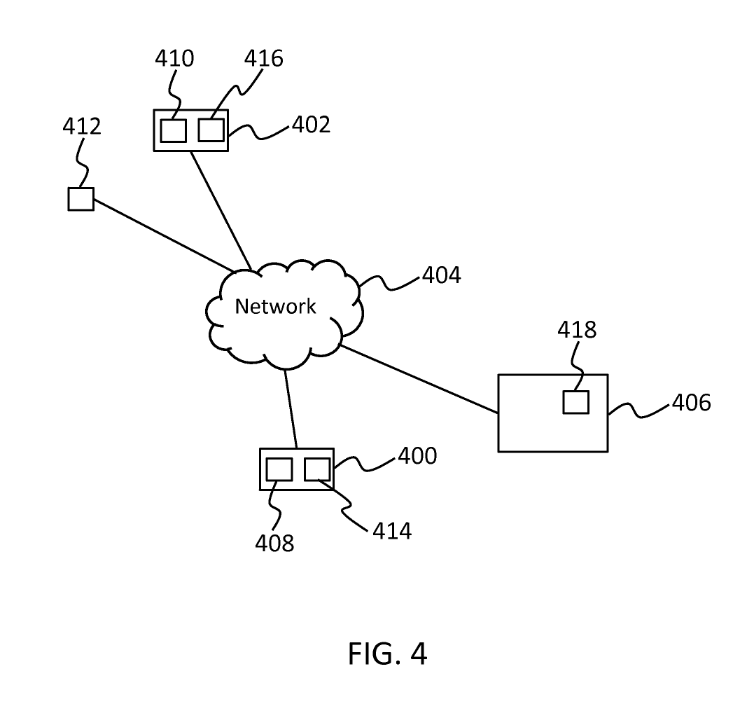

FIG. 2 is a simplified block diagram of a system according to an embodiment of the instant invention. A first user system 200 is provided in communication with a second user system 202, via a communication network 204. For instance, the communication network 204 is an Internet Protocol (IP) network. The first user system 200 is associated with a first user and the second user system 202 is associated with a second user. A first electronic sensor 206 is co-located with the second user system 202. In the instant example, the first electronic sensor 206 is, for instance, a network (IP) camera capable of streaming video data to the first user system 200 via the communication network 204. In this example, the first electronic sensor 206 is not in communication with the second user system 202. For instance, the first electronic sensor 206 is a security camera that is dedicated to providing video data to the first system 200. Optionally, the first electronic sensor 206 senses one or more of audio, image and video data. In one implementation, the first electronic sensor 206 is an edge device that is capable of performing one or more of audio, image and video analytics of the one or more of audio, image and video data that are sensed thereby.

In order to support bidirectional audio and video communication between the first user and the second user, the first user system 200 comprises a second electronic sensor 208 and the second user system 202 comprises a third electronic sensor 210. In one specific implementation, both the first user system 200 and the second user system 202 each comprise both an audio sensor and a video sensor. By way of a specific and non-limiting example, the first user system 200 and the second user system 202 each comprise a microphone and a web cam or another type of video camera. Optionally, one or both of the microphone and the web cam are external peripheral devices of the first and second user systems. Optionally, one or both of the microphone and the web cam are integrated devices of the first and second user systems.

The first user system 200 further comprises a processor 212 and the second user system 202 further comprises a processor 214, the processors 212 and 214 being for executing machine readable code for implementing at least one of an email application, a social networking application, a Voice over Internet Protocol (VoIP) application such as for instance Skype®, an instant messaging (IM) application, or another communication application. Furthermore, the processor 212 is for analyzing data that are sensed using the first electronic sensor 206. In particular, the analysis comprises at least one of audio, image and video analytics of the sensed data. More particularly, the analysis comprises comparing the sensed data with template data relating to a predetermined trigger event. In one implementation, the predetermined trigger event is one event of a compound event, which comprises the predetermined trigger event and at least one additional event.

During use, the electronic sensor 206 is used to sense data within a sensing area thereof. For instance, the electronic sensor 206 senses at least one of audio, image and video data within the sensing area. The sensed data is provided to processor 212 of the first user system 200, via communication network 204. Using a process in execution on the processor 212, at least one of audio, image and video analytics of the sensed data is performed. In particular, the analysis comprises comparing the sensed data with template data relating to a predetermined trigger event. When a result of the analysis is indicative of an occurrence of the predetermined trigger event within the sensing area, a communication session is automatically initiated for communicating with an individual within the predetermined sensing area. For instance, a communication session is initiated between the first user system 200 and the second user system 202. By way of a specific and non-limiting example, the communication session is a bidirectional Voice over Internet Protocol (VoIP) communication. Optionally, the communication session comprises a video component and an audio component.

A specific and non-limiting example is provided in order to facilitate a better understanding of operating principles of the system according to FIG. 2. In the specific and non-limiting example, the sensor 206 is a video camera that is co-located with the second user system 202, the first user system 200 is located within the premises of a first individual, and the second user system 202 is located within the premises of the elderly parent of the first individual. The sensor 206, the first user system 200 and the second user system 202 are Internet connected devices. The first user system 200 and the second user system 202 each comprise a display screen and speakers. A predetermined trigger event is defined in terms of the elderly parent falling to the ground. Optionally, a plurality of additional trigger events are defined, such as for instance identifying uniquely the elderly parent, the elderly parent walking with a shuffling gait, or the elderly parent remaining motionless. During use, the sensor 206 captures video data within a sensing area of the elderly parent's premises, such as for instance the living room of the elderly parent's premises, in a substantially continuous fashion. The captured video data is provided via communication network 204 to processor 212 of the first user system 200. A video analytics process in execution on processor 212 performs video analytics of the captured video data. In particular, the video analytics comprises comparing the captured video data with template data relating to the predetermined trigger event. When a result of the video analytics is indicative of an occurrence of the predetermined trigger event, a communication session is initiated between the first system 200 and the second system 202. In this specific example, a bidirectional VoIP communication session is initiated. Optionally, the VoIP communication session is a tele-video session, allowing the first individual to both see and speak to the elderly parent. Based on an assessment of the situation during the communication session, the first individual may determine whether or not the elderly parent requires an outside response.

Optionally, the predetermined trigger event is a compound event, comprising a first trigger event and a second trigger event. For instance, the first event is defined in terms of the elderly parent falling to the ground and the second event is defined in terms of the elderly parent failing to stand up after falling. At least a process in execution on the processor 212 of the first user system 202 is used to detect an occurrence of both the first event and the second event prior to initiating the communication session. Alternatively, the sensor 206 is an edge device that is capable of performing analysis of the data that is captured thereby. Optionally, the sensor 206 is used to detect an occurrence of the first event and a process in execution on the processor 212 of the first user system is used to detect an occurrence of the second event. In this way, the occurrence of false alarms is reduced and the elderly parent is able to live with greater independence and privacy. Optionally, the compound event includes a combination of audio and visual events. For instance, the first event is a visual event defined in terms of the elderly parent falling to the ground and the second event is an audio event defined in terms of the elderly parent calling for help.

In one implementation, the sensor 206 is a video camera that captures individual frames of image data at known time intervals. The individual frames are analyzed using an on-board process that is in execution on the sensor 206 to determine when the elderly parent has fallen to the ground. When it is determined that the parent has fallen to the ground, the sensor begins transmitting full frame-rate video to the first user system 200 via communication network 204. A process in execution on the processor 212 of the first user system 200 performs video analytics to detect another trigger event, such as for instance the elderly parent remaining motionless or the elderly parent failing to stand up. When a result of the video analytics is indicative of an occurrence of the other trigger event, a communication session is initiated between the first system 200 and the second system 202. In this specific example, a bidirectional VoIP communication session is initiated. Optionally, the VoIP communication session is a tele-video session, allowing the first individual to both see and speak to the elderly parent. Based on an assessment of the situation during the communication session, the first individual may determine whether or not the elderly parent requires an outside response. Since the time interval between individual frames typically is relatively short, for instance between 1 second and 10 seconds, the response time is not increased substantially. Optionally, the video camera (sensor 206) captures full frame-rate video for storage in a memory device local to the second user system 202. The full frame-rate video is not provided to a remote location, such as the first user system 200, until image analysis of the individual frames is indicative of an occurrence of the trigger event. In this case, the second user is afforded a substantial level of privacy.

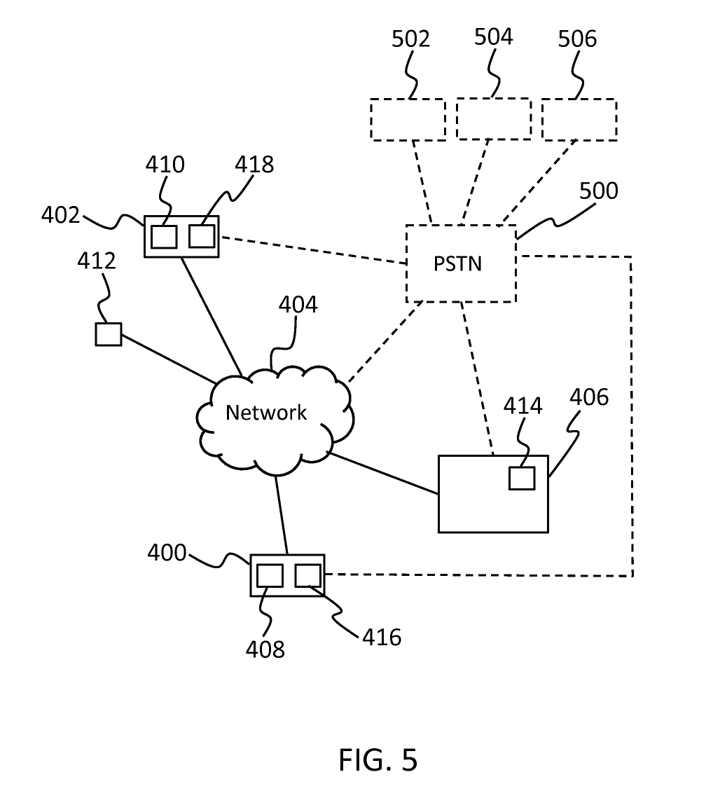

FIG. 3 is a simplified block diagram of a system according to an embodiment of the instant invention. A first user system 300 is provided in communication with a second user system 302, via a communication network 304. For instance, the communication network 304 is an Internet Protocol (IP) network. A third system 306 is also in communication with at least one of the first user system 300 and the second user system 302 via the communication network 304. The first user system 300 is associated with a first user and the second user system 302 is associated with a second user. At least the second user system 302 comprises an electronic sensor 308 for sensing data within a sensing area thereof. For instance, the electronic sensor 308 is one of an audio sensor for sensing audio data and an image sensor for sensing image or video data. In order to support bidirectional audio and video communication between the first user and the second user, the first user system 300 also comprises an electronic sensor 310. In one specific implementation, both the first user system 300 and the second user system 302 each comprise both an audio sensor and a video sensor. By way of a specific and non-limiting example, the first user system 300 and the second user system 302 each comprise a microphone and a web cam or another type of video camera. Optionally, one or both of the microphone and the web cam are external peripheral devices of the first and second user systems. Optionally, one or both of the microphone and the web cam are integrated devices of the first and second user systems.

The first user system 300 further comprises a processor 312 and the second user system 302 further comprises a processor 314, the processors 312 and 314 being for executing machine readable code for implementing at least one of an email application, a social networking application, a Voice over Internet Protocol (VoIP) application such as for instance Skype®, an instant messaging (IM) application, or another communication application.

The third system 306 also comprises a processor 316 for analyzing data that are sensed using the first electronic sensor 308. In particular, the analysis comprises at least one of audio, image and video analytics of the sensed data. More particularly, the analysis comprises comparing the sensed data with template data relating to a predetermined trigger event. In one implementation, the predetermined trigger event is one event of a compound event, which comprises the predetermined trigger event and at least one additional event. Optionally, the third system 306 is a server farm comprising a plurality of processors for implementing a plurality of processes. Further optionally, the third system 306 is a broker system in communication with at least another system (not illustrated), for brokering the at least one of audio, image or video analytics processes. In one particular implementation, the electronic sensor 308 captures video data continuously and the video data is streamed to the third system 306. Optionally, the electronic sensor 308 senses one or more of audio, image and video data. In another implementation, the electronic sensor 308 senses data and the processor 314 performs analysis of the sensed data to detect a first trigger event. When the first trigger event is detected, the sensed data begins streaming to the third system 306, where analysis is performed using a process in execution on processor 316 for at least one of confirming the occurrence of the first trigger event and detecting a second trigger event. Optionally, the electronic sensor 308 is an edge device that is capable of performing the one or more of audio, image and video analytics of the data that are sensed thereby.

During use, the electronic sensor 308 is used to sense data within a sensing area thereof. For instance, the electronic sensor 308 senses at least one of audio, image and video data within the sensing area. The sensed data is provided to processor 316 of the third system 306, via communication network 304. Using a process in execution on the processor 316, at least one of audio, image and video analytics of the sensed data is performed. In particular, the analysis comprises comparing the sensed data with template data relating to a predetermined trigger event. When a result of the analysis is indicative of an occurrence of the predetermined trigger event within the sensing area, a communication session is automatically initiated for communicating with an individual within the predetermined sensing area. For instance, the third system 306 initiates a communication session between the first user system 300 and the second user system 302. By way of a specific and non-limiting example, the communication session is a bidirectional Voice over Internet Protocol (VoIP) communication. Optionally, the communication session comprises a video component and an audio component.

A specific and non-limiting example is provided in order to facilitate a better understanding of the operation of the system according to FIG. 3. In this specific and non-limiting example, the electronic sensor 308 is a video camera, the first user system 300 is located within the premises of a first individual, and the second user system 302 is located within the premises of the elderly parent of the first individual. The first user system 300 and the second user system 302 are Internet connected devices, and each comprises a display screen and speakers. A predetermined trigger event is defined in terms of the elderly parent falling to the ground. Optionally, a plurality of additional trigger events are defined, such as for instance identifying uniquely the elderly parent, the elderly parent walking with a shuffling gait, or the elderly parent remaining motionless. During use, the electronic sensor 308 captures video data within a sensing area of the elderly parent's premises, such as for instance the living room of the elderly parent's premises, in a substantially continuous fashion. The captured video data is provided via communication network 304 to processor 316 of the third system 306. A video analytics process in execution on processor 316 performs video analytics of the captured video data. In particular, the video analytics comprises comparing the captured video data with template data relating to the predetermined trigger event. When a result of the video analytics is indicative of an occurrence of the predetermined trigger event, a communication session is initiated between the first system 300 and the second system 302. In this specific example, a bidirectional VoIP communication session is initiated. Optionally, the VoIP communication session is a tele-video session, allowing the first individual to both see and speak to the elderly parent. Based on an assessment of the situation during the communication session, the first individual may determine whether or not the elderly parent requires an outside response.

Optionally, the predetermined trigger event is a compound event, comprising a first trigger event and a second trigger event. For instance, the first event is defined in terms of the elderly parent falling to the ground and the second event is defined in terms of the elderly parent failing to stand up after falling. At least a process in execution on the processor 316 of the third system 306 is used to detect an occurrence of both the first event and the second event prior to initiating the communication session. In this way, the occurrence of false alarms is reduced and the elderly parent is able to live with greater independence and privacy. Optionally, the compound event includes a combination of audio and visual events. For instance, the first event is a visual event defined in terms of the elderly parent falling to the ground and the second event is an audio event defined in terms of the elderly parent calling for help.

Optionally, the video camera (sensor 308) captures frames of image data at known time intervals, and the individual frames are transmitted to the third system 306 via the communication network 304. A process in execution on the processor 316 of the third system 306 performs image analysis, such as to determine when the parent has fallen to the ground. When it is determined that the parent has fallen to the ground, the first user system 300 transmits a request to the second user system 302, via communication network 304, requesting full frame-rate video. In response to the request, the video camera begins providing full frame-rate video data, and a process in execution on the processor 316 of the third system 306 performs video analytics to detect another trigger event, such as for instance the elderly parent remaining motionless or the elderly parent failing to stand up. When a result of the video analytics is indicative of an occurrence of the other trigger event, a communication session is initiated between the first system 300 and the second system 302. In this specific example, a bidirectional VoIP communication session is initiated. Optionally, the VoIP communication session is a tele-video session, allowing the first individual to both see and speak to the elderly parent. Based on an assessment of the situation during the communication session, the first individual may determine whether or not the elderly parent requires an outside response. Since the time interval between individual frames typically is relatively short, for instance between 1 second and 10 seconds, the response time is not increased substantially. Optionally, the video camera (sensor 308) captures full frame-rate video for storage in a memory device local to the second user system 302. The full frame-rate video is not provided to a remote location, such as the third system 306, until image analysis of the individual frames is indicative of an occurrence of the trigger event. In this case, the second user is afforded a substantial level of privacy.

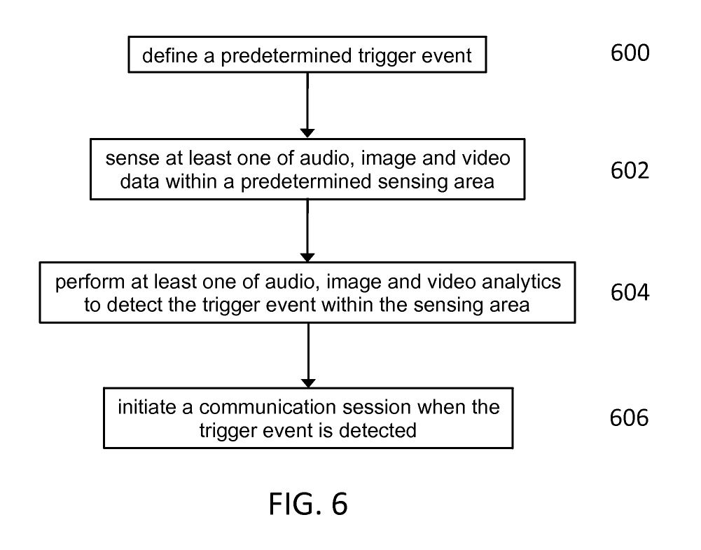

FIG. 4 is a simplified block diagram of a system according to an embodiment of the instant invention. A first user system 400 is provided in communication with a second user system 402, via a communication network 404. For instance, the communication network 404 is an Internet Protocol (IP) network. A third system 406 is also in communication with at least one of the first user system 400 and the second user system 402 via the communication network 404. The first user system 400 is associated with a first user and the second user system 402 is associated with a second user.

The first user system 400 comprises a processor 408 and the second user system 402 comprises a processor 410, the processors 408 and 410 are for executing machine readable code for implementing at least one of an email application, a social networking application, a Voice over Internet Protocol (VoIP) application such as for instance Skype®, an instant messaging (IM) application, or another communication application.

A first electronic sensor 412 is co-located with the second user system 402. In the instant example, the first electronic sensor 412 is, for instance, a network (IP) camera capable of streaming video data to the third system 406 via the communication network 404. In this example, the first electronic sensor 412 is not in communication with the second user system 402. For instance, the first electronic sensor 412 is a security camera that is dedicated to providing video data to the third system 406, which is for instance a video analytics server or a server farm having in execution thereon at least one video analytics process for performing video analytics of video data that is received from the first electronic sensor 412. In one particular implementation, the first electronic sensor 412 captures video data continuously and the video data is streamed to the third system 406. Optionally, the first electronic sensor 412 senses one or more of audio, image and video data. In another implementation, the first electronic sensor 412 is an edge device, in which case the first electronic sensor 412 senses data and performs on-board analysis of the sensed data to detect an occurrence of a first trigger event. When the first trigger event is detected, the sensed data begins streaming to the third system 406, where analysis is performed for at least one of confirming the first trigger event and detecting a second trigger event.

The third system 406 also comprises a processor 414 for analyzing data that are sensed using the first electronic sensor 412. In particular, the analysis comprises at least one of audio, image and video analytics of the sensed data. More particularly, the analysis comprises comparing the sensed data with template data relating to a predetermined trigger event. In one implementation, the predetermined trigger event is one event of a compound event, which comprises the predetermined trigger event and at least one additional event. Optionally, the third system 406 is a server farm comprising a plurality of processors for implementing a plurality of processes. Further optionally, the third system 406 is a broker system in communication with at least another system, for brokering the at least one of audio, image or video analytics processes.

In order to support bidirectional audio and video communication between the first user and the second user, the first user system 400 comprises a second electronic sensor 416 and the second user system 402 comprises a third electronic sensor 418. In one specific implementation, both the first user system 400 and the second user system 402 each comprise both an audio sensor and a video sensor. By way of a specific and non-limiting example, the first user system 400 and the second user system 402 each comprise a microphone and a web cam or another type of video camera. Optionally, one or both of the microphone and the web cam are external peripheral devices of the first and second user systems. Optionally, one or both of the microphone and the web cam are integrated devices of the first and second user systems.

During use, the first electronic sensor 412 is used to sense data within a sensing area thereof. For instance, the electronic sensor 412 senses at least one of audio, image and video data within the sensing area. The sensed data is provided to processor 414 of the third system 406, via communication network 404. Using a process in execution on the processor 414, at least one of audio, image and video analytics of the sensed data is performed. In particular, the analysis comprises comparing the sensed data with template data relating to a predetermined trigger event. When a result of the analysis is indicative of an occurrence of the predetermined trigger event within the sensing area, a communication session is automatically initiated for communicating with an individual within the predetermined sensing area. For instance, the third system 406 initiates a communication session between the first user system 400 and the second user system 402. By way of a specific and non-limiting example, the communication session is a bidirectional Voice over Internet Protocol (VoIP) communication. Optionally, the communication session comprises a video component and an audio component.

A specific and non-limiting example is provided in order to facilitate a better understanding of operating principles of the system according to FIG. 4. In the specific and non-limiting example, the first sensor 412 is a video camera that is co-located with the second user system 402, the first user system 400 is located within the premises of a first individual, and the second user system 402 is located within the premises of the elderly parent of the first individual. The first sensor 412, the first user system 400 and the second user system 402 are Internet connected devices. The first user system 400 and the second user system 402 each comprise a display screen and speakers. A predetermined trigger event is defined in terms of the elderly parent falling to the ground. Optionally, a plurality of additional trigger events are defined, such as for instance identifying uniquely the elderly parent, the elderly parent walking with a shuffling gait, or the elderly parent remaining motionless. During use, the first sensor 412 captures video data within a sensing area of the elderly parent's premises, such as for instance the living room of the elderly parent's premises, in a substantially continuous fashion. The captured video data is provided via communication network 404 to processor 414 of the third system 400. A video analytics process in execution on processor 414 performs video analytics of the captured video data. In particular, the video analytics comprises comparing the captured video data with template data relating to the predetermined trigger event. When a result of the video analytics is indicative of an occurrence of the predetermined trigger event, a communication session is initiated between the first system 400 and the second system 402. In this specific example, a bidirectional VoIP communication session is initiated. Optionally, the VoIP communication session is a tele-video session, allowing the first individual to both see and speak to the elderly parent. Based on an assessment of the situation during the communication session, the first individual may determine whether or not the elderly parent requires an outside response.

Optionally, the predetermined trigger event is a compound event, comprising a first trigger event and a second trigger event. For instance, the first event is defined in terms of the elderly parent falling to the ground and the second event is defined in terms of the elderly parent failing to stand up after falling. At least a process in execution on the processor 414 of the third system 406 is used to detect an occurrence of both the first event and the second event prior to initiating the communication session. Alternatively, the first sensor 412 is an edge device that is capable of performing analysis of the data that is captured thereby. Optionally, the first sensor 412 is used to detect an occurrence of the first event and a process in execution on the processor 414 of the third system is used to detect an occurrence of the second event. In this way, the occurrence of false alarms is reduced and the elderly parent is able to live with greater independence and privacy. Optionally, the compound event includes a combination of audio and visual events. For instance, the first event is a visual event defined in terms of the elderly parent falling to the ground and the second event is an audio event defined in terms of the elderly parent calling for help.

In one implementation, the first sensor 412 is a video camera that captures individual frames of image data at known time intervals. The individual frames are analyzed using an on-board process that is in execution on the first sensor 412 to determine when the elderly parent has fallen to the ground. When it is determined that the parent has fallen to the ground, the sensor begins transmitting full frame-rate video to the third system 406 via communication network 404. A process in execution on the processor 414 of the third system 406 performs video analytics to detect another trigger event, such as for instance the elderly parent remaining motionless or the elderly parent failing to stand up. When a result of the video analytics is indicative of an occurrence of the other trigger event, a communication session is initiated between the first system 400 and the second system 402. In this specific example, a bidirectional VoIP communication session is initiated. Optionally, the VoIP communication session is a tele-video session, allowing the first individual to both see and speak to the elderly parent. Based on an assessment of the situation during the communication session, the first individual may determine whether or not the elderly parent requires an outside response. Since the time interval between individual frames typically is relatively short, for instance between 1 second and 10 seconds, the response time is not increased substantially. Optionally, the video camera (first sensor 412) captures full frame-rate video for storage in a memory device local to the second user system 402. The full frame-rate video is not provided to a remote location, such as the third system 406, until image analysis of the individual frames is indicative of an occurrence of the trigger event. In this case, the second user is afforded a substantial level of privacy.

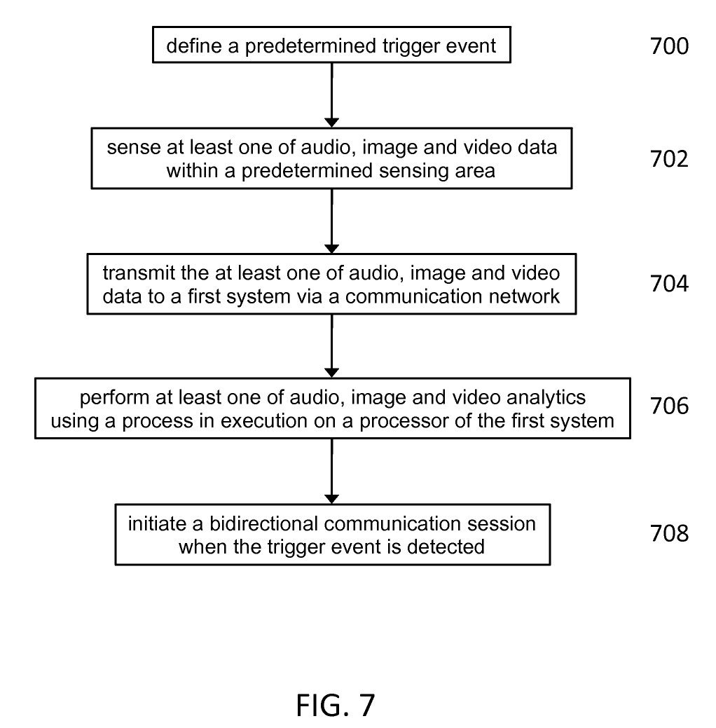

FIG. 5 is a simplified block diagram of a system according to an embodiment of the instant invention. The system is substantially similar to the system that is shown in FIG. 4, but additionally the first user system 400, the second user system 402 and the third system 406 are in communication with the public switched telephone network (PSTN). Optionally, the systems of any of FIGS. 1-3 are adapted such that one or more of the first user system, the second user system, and the third user system is in communication with the PSTN. According to FIG. 5, communication between the first user and the second user may be established via the PSTN. Alternatively, when a trigger event is detected one of the first user system, the second user system and the third system automatically initiates a telephone call via the PSTN to an external responder, such as for instance a neighbor 502, the police 504, or an ambulance service.

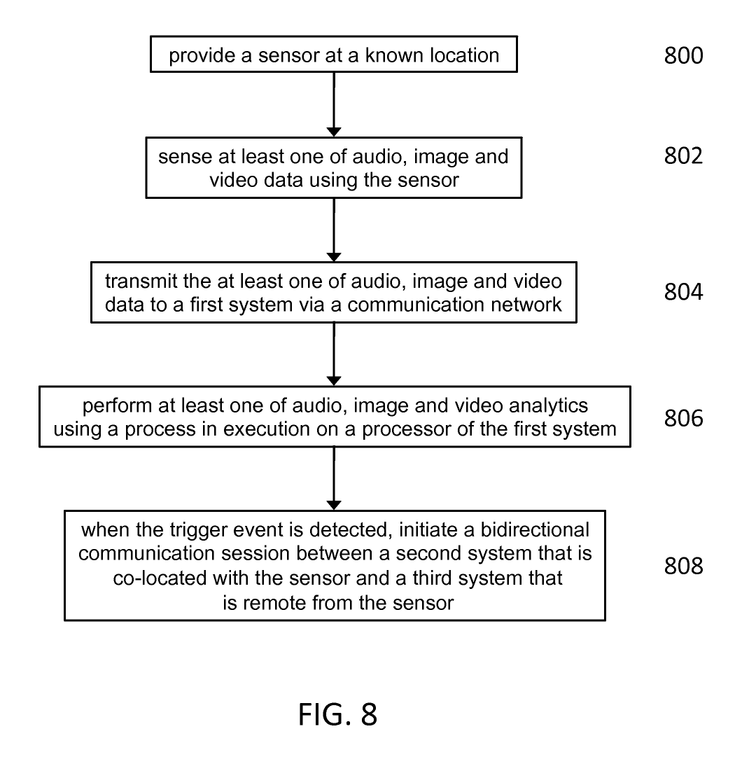

Referring now to FIG. 6, shown is a simplified flow diagram of a method according to an embodiment of the instant invention. At 600 a predetermined trigger event is defined, such as for instance an elderly parent falling to the ground or identification of an individual. At 602, using a sensor, at least one of audio, image and video data are sensed within a predetermined sensing area. At 604, using a process in execution on a processor of a first system, at least one of audio, image and video analytics of the at least one of audio, image and video data is performed, to detect an occurrence of the predetermined trigger event within the predetermined sensing area. At 606, when a result of the at least one of audio, image and video analytics is indicative of an occurrence of the predetermined trigger event, a communication session for communicating with an individual within the predetermined sensing area is initiated automatically.

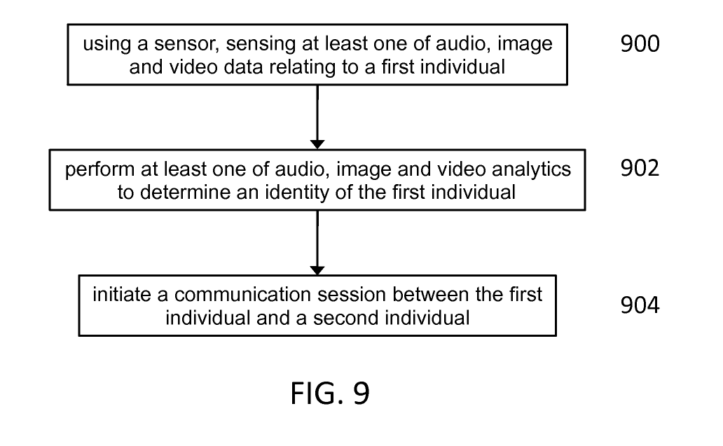

Referring now to FIG. 7, shown is a simplified flow diagram of a method according to an embodiment of the instant invention. At 700 a predetermined trigger event is defined, such as for instance an elderly parent falling to the ground or identification of an individual. At 702, using a sensor, at least one of audio, image and video data are sensed within a predetermined sensing area. At 704 the sensed at least one of audio, image and video data are transmitted to a first system via a communication network. At 706, using a process in execution on a processor of the first system, at least one of audio, image and video analytics of the at least one of audio, image and video data is performed, to detect an occurrence of the predetermined trigger event within the predetermined sensing area. At 708, when a result of the at least one of audio, image and video analytics is indicative of an occurrence of the predetermined trigger event, a bidirectional communication session for communicating with an individual within the predetermined sensing area is initiated automatically.

Referring now to FIG. 8, shown is a simplified flow diagram of a method according to an embodiment of the instant invention. At 800 a sensor is provided at a known location for sensing at least one of audio, image and video data within a sensing area at the known location. At 802, using the sensor, at least one of audio, image and video data are sensed within the sensing area. At 804 the sensed at least one of audio, image and video data are transmitted from the sensor to a first system via a communication network. At 806, using a process in execution on a processor of the first system, at least one of audio, image and video analytics of the at least one of audio, image and video data is performed, to detect an occurrence of a predetermined trigger event at the known location. At 808, when a result of the at least one of audio, image and video analytics is indicative of an occurrence of the predetermined trigger event, a bidirectional communication session between a second system that is co-located with the sensor and a third system that is remote from the sensor is initiated automatically, for communicating with an individual within the predetermined sensing area.

Referring now to FIG. 9, shown is a simplified flow diagram of a method according to an embodiment of the instant invention. At 900 a sensor is used to sense at least one of audio, image and video data relating to a first individual. At 902, using a process in execution on a processor of a first system, at least one of audio, image and video analytics of the at least one of audio, image and video data is performed, to determine an identity of the first individual. At 904 a communication session between the first individual and a second individual is initiated, wherein the second individual is selected based on the determined identity of the first individual, from a group of second individuals that are associated with the first individual.

Some additional examples, illustrative of initiating a communication session based on detecting a trigger event using video analytics, are presented below.

Contest/Competition:

A sensor is set up to monitor an area, within which area individuals are challenged to perform some action. For instance, individuals are invited to attempt to putt a golf ball into a cup that is arranged some distance away. In dependence upon a video analytics process determining that an individual legitimately putts the golf ball into the cup, according to predetermined rules, a communication session is initiated automatically between the location of the sensor and a call center. An employee at the call center subsequently communicates with the individual to offer congratulations and prize information.

Employee Monitoring

A sensor is set up in an employee's workspace, such as for instance the employee's office. In dependence upon a video analytics process determining that the employee is asleep in his or her office, a communication session is initiated automatically between the employee's supervisor and the employee.

Home/Office Security

A sensor is set up in an individual's home or office. In dependence upon a video analytics process determining that an unauthorized individual is present within the individual's home (for instance), a communication session is initiated automatically between the individual and the unauthorized individual. For instance, the communication session is initiated between a system located at the individual's office and another system located in the individual's home.

Face Dialing

In this particular application the trigger event is defined in terms of either identifying uniquely an individual, or classifying an individual as belonging to a known group. Once the trigger event is detected, a communication session is initiated. By way of a specific and non-limiting example, an office space with restricted access during non-business hours is provided with an entrance area within which a first user system (including video and/or audio sensors and video and/or audio output devices such as a display screen and speakers, respectively) is located. When an individual approaches the office space via the entrance area, an electronic sensor captures video and or audio data relating to the individual. At least one of video, image and audio analytics is performed to either identify the individual uniquely, or to classify the individual within a known group, such as for instance courier, delivery, janitor, etc. If the individual is identified uniquely and is determined as being likely one of a known first user's contacts, then a communication session is initiated between the first user and the individual. For instance, if Mrs. X is working late and her husband, Mr. X, arrives to pick her up, then upon identifying Mr. X within the entrance area, a communication session is initiated between Mr. X and Mrs. X. Mrs. X may then communicate to her husband that she is on her way to the entrance area. Alternatively, if the individual is classified as a courier, then a communication session is initiated between the individual and a concierge or other designated individual, such as a receptionist.

Optionally, upon being uniquely identified and recognized as an authorized individual, access to the restricted access area is granted automatically to the individual. For instance, in response to uniquely identifying the individual, a signal is transmitted from a central system for changing a contact, so as to open a door between the entrance area and the restricted access area.

Optionally, when the individual is recognized as someone who works within the restricted access area, then the trigger event (e.g. recognizing the individual) may be used to initiate a number of other actions. For instance, when the trigger event is detected, an office alarm system may be disabled, lighting levels and/or other environmental conditions within the restricted access area may be adjusted, the phone system may be taken off night-mode, etc.

Alternatively, the face dialing application is used in a home or business setting in which a plurality of different users share a same computer system. Template data is stored for each of the plurality of users. Subsequently, when a first user is at the computer system, at least one of video, image and audio analytics of sensed data relating to the first user is performed, for identifying the first user. In response to this trigger event, either a communication session is initiated automatically between the first user and a default contact, or the first user is provided with a list of contacts of the first user, and a communication session is initiated when the first user selects a contact from the list of contacts.

Caller ID

In yet another application, the trigger event is defined in terms of identifying uniquely an individual at a first computer system. In response to the trigger event, a communication session is initiated (either manually or automatically), including providing an indication of the identity of the individual. For instance, in a home setting in which a plurality of different users share a same computer system, template data is stored for each of the plurality of users. Subsequently, when a first user is at the computer system, at least one of video, image and audio analytics of sensed data relating to the first user is performed, for identifying the first user. In response to this trigger event (identifying the first user), either a communication session is initiated automatically between the first user and a default contact, or the first user is provided with a list of contacts of the first user, and a communication session is initiated when the first user selects a contact from the list of contacts. The communication session includes transmitting to the contact a signal indicative of the unique ID of the first user. Thus, when an adult initiates a communication session with his or her parent, the parent is aware that it is the adult, and not the grandchildren, calling.

Object Removal/Addition Detection

Another suitable trigger event is the addition or removal of an object within the sensing area of an electronic sensor. For instance, a camera captures image or video data within a field of view (FOV) thereof. When an object suddenly appears within the FOV (the trigger event) a notification is transmitted to a designated individual. For instance, the designated individual is a security guard. Alternatively, the trigger event comprises assessing a risk level associated with the object. If a risk level above a predetermined threshold is determined, then a warning, such as for instance an alarm, is sounded for signaling an evacuation. Of course, if an object suddenly disappears from the FOV (the trigger event) then a potential theft incident may be determined. In this case, optionally a notification is transmitted to a designated individual, or to a security or police force, etc. Optionally, a communication session is initiated between a local security representative and the police. Further optionally, in response to detecting the removal of the object, another action is taken, such as for instance sounding an alarm, activating analytics processes of data that is sensed using other sensors, or increasing the lighting level.

Numerous other embodiments may be envisaged without departing from the scope of the invention.

What is claimed is:

1. A method comprising:
defining a predetermined trigger event;
using a sensor, sensing at least one of audio, image and video data within a predetermined sensing area;
using a process in execution on a processor of a first system, performing at least one of audio, image and video analytics of the at least one of audio, image and video data, to detect an occurrence of the predetermined trigger event within the predetermined sensing area; and,
when a result of the at least one of audio, image and video analytics is indicative of an occurrence of the predetermined trigger event, automatically initiating a communication session for communicating with an individual within the predetermined sensing area.

2. A method according to claim 1, wherein the first system is co-located with the sensor, and wherein the communication session is between the first system and a second system that is remote from the sensor.

3. A method according to claim 1, wherein the first system is remote from the sensor, and wherein the communication session is between the first system and a second system that is co-located with the sensor.

4. A method according to claim 1, wherein the first system is a network server, and wherein the communication session is between a second system that is co-located with the sensor and a third system that is remote from the server.

5. A method according to claim 1, wherein the predetermined trigger event is a second event of a compound trigger event, the compound trigger event comprising a first event and the second event.

6. A method according to claim 1, wherein the predetermined trigger event comprises identifying uniquely the individual within the predetermined sensing area, based on the at least one of audio, image and video analytics of the at least one of audio, image and video data.

7. A method comprising:
defining a predetermined trigger event;
using a sensor, sensing at least one of audio, image and video data within a predetermined sensing area;
transmitting the sensed at least one of audio, image and video data to a first system via a communication network;
using a process in execution on a processor of the first system, performing at least one of audio, image and video analytics of the at least one of audio, image and video data, to detect an occurrence of the predetermined trigger event within the predetermined sensing area; and,
when a result of the at least one of audio, image and video analytics is indicative of an occurrence of the predetermined trigger event, automatically initiating a bidirectional communication session for communicating with an individual within the predetermined sensing area.

8. A method according to claim 7, wherein the communication network is an Internet Protocol (IP) network.

9. A method according to claim 7, wherein the bidirectional communication session is between the first system and a second system that is co-located with the sensor.

10. A method according to claim 7, wherein the first system is a network server, and wherein the bidirectional communication session is between a second system that is co-located with the sensor and a third system, the third system in communication with the first system and with the second system via the communication network.

11. A method according to claim 7, wherein the predetermined trigger event is a second event of a compound trigger event, the compound trigger event comprising a first event and the second event.

12. A method according to claim 11, wherein the sensor is an edge device, and comprising performing first at least one of audio, image and video analytics of the at least one of audio, image and video data to detect an occurrence of the first event within the predetermined sensing area.

13. A method according to claim 12, wherein the sensed at least one of audio, image and video data is transmitted from the sensor to the first system in response to detecting the occurrence of the first event within the predetermined sensing area.

14. A method according to claim 13, wherein transmitting is performed prior to using the processor of the first system for performing the at least one of audio, image and video analytics of the at least one of audio, image and video data.

15. A method comprising:
providing a sensor at a known location for sensing at least one of audio, image and video data within a sensing area at the known location;
using the sensor, sensing at least one of audio, image and video data within the sensing area thereof;
transmitting the sensed at least one of audio, image and video data from the sensor to a first system via a communication network;
using a process in execution on a processor of the first system, performing at least one of audio, image and video analytics of the at least one of audio, image and video data, to detect an occurrence of a predetermined trigger event at the known location; and,
when a result of the at least one of audio, image and video analytics is indicative of an occurrence of the predetermined trigger event, automatically initiating a bidirectional communication session between a second system that is co-located with the sensor and a third system that is remote from the sensor, for communicating with an individual within the predetermined sensing area.

16. A method according to claim 15, wherein the communication network is an Internet Protocol (IP) network.

17. A method according to claim 15, wherein sensing comprises capturing video data using a video capture device, and wherein performing comprises performing video analytics of the video data.

18. A method according to claim 15, wherein the predetermined trigger event is a second event of a compound trigger event, the compound trigger event comprising a first event and the second event.

19. A method according to claim 18, wherein the sensor is an edge device, and comprising performing first at least one of audio, image and video analytics of the at least one of audio, image and video data to detect an occurrence of the first event within the predetermined sensing area.

20. A method according to claim 19, wherein the sensed at least one of audio, image and video data is transmitted from the sensor to the first system in response to detecting the occurrence of the first event within the predetermined sensing area.

21. A method according to claim 20, wherein transmitting is performed prior to using the process in execution on the processor of the first system for performing the at least one of audio, image and video analytics of the at least one of audio, image and video data.
